(19) United States
(12) Patent Application Publication
(10) Pub. No.: US 2022/0201940 A1
(43) Pub. Date: Jun. 30, 2022

(54) DELIVERY DEVICES, SYSTEMS AND METHODS OF USE

(71) Applicant: Invaio Sciences International GmbH, Basel (CH)

(72) Inventors: Lukas Rudolf SCHUPBACH, Basel (CH); Urs WIDMER, Dornach (CH); Michael Christian OEHL, Reinach (CH)

(73) Assignee: Invaio Sciences International GmbH, Basel (CH)

(21) Appl. No.: 17/603,542

(22) PCT Filed: Apr. 17, 2020
(86) PCT No.: PCT/EP2020/060928

§ 371 Date: Oct. 13, 2021

(30) Foreign Application Priority Data
Apr. 17, 2019 (CH) 00525/19

(51) Int. Cl. A01G 7/06; A01G 17/00

(52) U.S. Cl. CPC A01G 7/06; A01G 17/00

(57) ABSTRACT

A delivery device (5) for injecting a liquid active ingredient formulation (4) into a plant comprises a vessel assembly (51, 52) having a distal side (512) and a proximal side (523), a delivery outlet (53) connected to the distal side (512) of the vessel assembly (51, 52), a product port (57) connected to the distal side (512) of the vessel assembly (51, 52), a dosing piston (511) movably arranged in the vessel assembly (51, 52) such that a variable product chamber (515; 595) is formed between the dosing piston (511) and the distal side (512) of the vessel assembly (51), a directional valve (54) connected to the proximal side (523) of the vessel assembly (51, 52), a proximal chamber (525) limited by the proximal side (523) of the vessel assembly (51, 52) and reciprocally variable relative to the product chamber (515), and a pressure medium port (541) connected to the directional valve (54). The directional valve (54) is configured to switch between a delivery position in which the proximal chamber (525) of the vessel assembly (51, 52) and the pressure medium port (541) are in fluid connection, and a charging position in which the proximal chamber (525) of the vessel assembly (52) and the pressure medium port (541) are fluid tight towards each other.

### CROSS-REFERENCE TO RELATED APPLICATIONS

This application claims the benefit of Switzerland Patent Application No. 00525/19, titled «Delivery Device and System», filed on Apr. 17, 2019, which is herein incorporated by refeference in its entirety.

### FIELD

This document relates to devices, systems including the devices, and methods of using the devices and systmes for administering formulations to plants, including injecting liquid formulations into plants.

### BACKGROUND

Tree injection has been used for administration of liquids into trees. Conventional tree injection approaches can involve drilling a borehole in a tree trunk and stoppering the borehole with a peg. A needle is inserted through the peg to discharge liquid into the borehole.

### SUMMARY

The present disclosure provides devices for delivering fluids, for example liquid formulations including one or more active ingredients (“AI fluid”), to a plant, for example directly into the interior of a plant (“plant injection device” or (“delivery device”). The delivery devices are configured such that in operation, both charging the delivery device with a fluid formulation and exhausting the delivery device of the fluid formulation, are pneumatically or hydraulically controlled. In some embodiments, charging and exhausting are both pneumatically controlled. In some embodiments, the delivery device is configured to hold only a single dose of fluid formulation and consequently is charged each time delivery of a dose of fluid formulation is desired. In other embodiments, the delivery device is configured to hold multiple doses of fluid formuation and consequently fluid may be exhausted from the delivery device and administered to a plant or plants multiple times without the need to charge the device after each delivery of a dose of fluid formulation. In some embodiments, the delivery device includes a vessel assembly which may be configured in the form of a pistol housing a dosing chamber for receiving, storing and releasing fluid formulation, and a pneumatic chamber operatively connected to the dosing chamber such that in use, the pneumatic chamber selectively results in the dosing chamber receiving fluid formulation or exhausting fluid formulation.

The present disclosure also provides systems comprising the delivery device for delivering fluids to plants (“plant fluid delivery system” or “delivery system”). In some embodiments, the systems include the delivery device, a product reservoir housing the fluid formulation, and pressure medium reservoir housing a pressure medium used in pneumatic or hydraulic control of the delivery device. The product reservoir is in selective fluid communication with the delivery device such that, in an open position fluid can flow from the product reservoir into the delivery device, and in a closed position, fluid does not flow into the delivery device from the product reservoir. The pressure medium reservoir may also be in selective fluid communication with the delivery device such that, in an open position fluid can flow from the pressure medium reservoir into the delivery device, and in a closed position, fluid does not flow into the delivery device from the pressure medium reservoir. In some embodiments, the devices and systems are configured for portability. For example, the device may be configured as a light-weight, hand-held device and the remaining system components may be configured to be carried in a satchel, back-pack or other bag.

In some embodiments, the delivery device comprises a vessel assembly, a delivery outlet, a product port, a dosing piston and a directional valve.

In some embodiments, the vessel assembly has a distal side and a proximal side. The term “distal” as used herein can relate to an orientation to be generally directed towards the plant to be treated. Typically, the active ingredient formulation is delivered or forwarded into a distal direction by the delivery device. In particular, such orientation can be an orientation in an intended use of the delivery device. Similarly, the term “proximal” as used herein can relate to an orientation generally facing away of the plant to be treated. Typically, the proximal direction is opposite to the distal direction. The distal or proximal sides of the vessel assembly may comprise the distal or proximal ends of the vessel assembly as well as, optionally, also other portions near the distal or proximal ends in a narrow sense.

The delivery outlet as well as the product port are connected to the distal side of the vessel assembly. The delivery outlet can have the shape of a spout. It can be equipped with an adapter structure to be connected to an injection member set into the plant. The directional valve is connected to the proximal side of the driving vessel. The pressure medium port is connected to the directional valve.

In this context, the term “connected” can relate to a fluid and/or physical connection allowing a transfer of fluid. Thereby, the delivery outlet and the product port can either be directly or indirectly arranged at or mounted to the distal side of the dosing vessel. Also, the directional valve can be directly or indirectly arranged at the proximal side of the driving vessel. For example, there can be a conduit in between the delivery outlet and/or the product port and the distal side of the dosing vessel. And/or, the product port can be mounted to a tube or pipe mounted to the dosing vessel. Similarly, the directional valve can be mounted to a tube or pipe mounted to the driving vessel. And/or, the pressure medium port can be mounted to a tube or pipe mounted to the directional valve.

The dosing piston is movably arranged in the vessel assembly such that a variable product chamber is formed between the dosing piston and the distal side of the vessel assembly. The dosing piston can be configured to tightly abut or contact an interior of an associated vessel. For this, it can be equipped with a gasket such as an O-ring or the like. Or, it can have an elasticity adapted to tightly contact the interior of the associated vessel. For allowing an efficient moving of the piston inside the respective vessel without losing tightness, the interior of the vessel can be provided with a lubricant such as a silicone oil or the like.

The directional valve is connected to the proximal side of the vessel assembly. A proximal chamber of the delivery device is limited by the proximal side of the vessel assembly. It further is reciprocally variable relative to the product chamber. The term “reciprocally variable relative to” in this connection relates to a change in size or volume of the proximal and product chambers. More specifically, the proximal chamber is reciprocally variable relative to the product chamber by increasing in size or volume when the size or volume of the product chamber decreases. Vice versa, the proximal chamber decreases in size or volume when the size or volume of the product chamber increases. The extent of decrease and increase in the chambers can correspond or be identical to each other or it can be different from each other.

The pressure medium port is connected to the directional valve. The directional valve is configured to switch between a delivery position in which the proximal chamber of the vessel assembly and the pressure medium port are in fluid connection, and a charging position in which the proximal chamber of the vessel assembly and the pressure medium port are fluid tight towards each other.

In use of the delivery device, a pressure medium reservoir can be coupled to the pressure medium port and an active ingredient formulation reservoir can be coupled to the product port. For loading the product chamber, the directional valve or the delivery device is in its charging position. The directional valve seals the proximal chamber of the vessel assembly from the pressure medium port. The dosing piston proximally moves such that the product chamber is enlarged. Thereby, active ingredient formulation can be withdrawn from its reservoir into the product chamber.

For providing the active ingredient formulation out of the delivery device, the directional valve is switched into its delivery position. The directional valve establishes a fluid connection between the proximal chamber of the vessel assembly and the pressure medium port. Like this, pressure medium advances into the proximal chamber and directly or indirectly displaces the dosing piston into a distal direction. Thereby, the active ingredient formulation is forwarded through the delivery outlet out of the product chamber.

By having the vessel assembly together with the dosing piston and the directional valve, an efficient and accurate delivery of the liquid active ingredient formulation can be achieved. Like this, the delivery device can be particularly suitable for a sophisticated injection of the liquid active ingredient formulation into the plant.

The vessel assembly can be or have one single vessel or a combination of plural vessels. Such single or plural vessels can be shaped as cylinders or cylinder-like containers. They can be made of glass, metal or a robust plastic.

In some embodiments, the delivery device is comfigured as follows: the vessel assembly comprises a dosing vessel having the distal side and a driving vessel having a distal side and the proximal side; the delivery device further comprises a driving piston movably arranged inside the driving vessel; the dosing piston is movable inside the dosing vessel; a variable distal chamber is formed between the driving piston, particularly a distal face thereof, and the distal side of the driving vessel; the variable proximal chamber is formed between the driving piston, particularly a proximal face thereof, and the proximal side of the driving vessel; and the driving piston is cinematically coupled to the dosing piston.

As the dosing piston also the driving piston can be configured to tightly abut or contact the interior of the associated vessel, i.e. the driving vessel. Thereby, it can be equipped with a gasket such as an O-ring or the like. Or, it can have an elasticity adapted to tightly contact the interior of the associated vessel. For allowing an efficient moving of the piston inside the driving vessel without losing tightness, the interior of the driving vessel can be provided with a lubricant such as silicone oil or the like.

In the embodiment having a dosing vessel and a driving vessel, the delivery outlet and the product port may be connected to the distal side of the dosing vessel.

In the charging position, the driving piston is moved into the proximal direction. For proximally moving the driving piston, a spring or the like can be coupled to the piston, or the pneumatic system of the delivery device can be configured as described in more detail below. Since the driving piston is cinematically coupled to the dosing piston, the two pistons move together in the proximal direction. The term “cinematically coupled” in this connection relates to a connection which causes the other piston moving as well when one of the pistons moves. In particular, the pistons can be rigidly coupled such that they move in common. For example, for that purpose, the pistons can be mounted to a rigid rod. Typically, the pistons move in an axial direction of the respective vessel.

When using pneumatic or hydraulic techniques to withdraw liquid active ingredient formulations to be dosed to plants, it may happen that the involved liquid active ingredient formulation is impaired or damaged. For example, comparably rapid pressure drop in the dosing vessel during charging may cause turbulences or even cavitation or other mechanical/chemical stress in the liquid which may have detrimental effects on the active ingredient formulation. Particularly, when liquids having a comparably high viscosity and/or sensible substances are involved such effects can be crucial for the efficacy of the treatment. Such situations are often given when biological or bio-chemical substances are included in the active ingredient formulation.

For addressing this problem, the delivery device may comprise a throttle valve arranged between the directional valve and the proximal side of the driving vessel. Such a throttle valve allows for selectively decreasing or adapting the pace of reduction of pressure inside the proximal chamber of the vessel assembly or of the driving vessel. Like this, the speed of proximally moving the dosing piston can be adapted and particularly reduced. Thus, the throttle valve allows for smoothly withdrawing the liquid active ingredient formulation into the product chamber such that its efficacy can efficiently be maintained.

Thereby, the throttle valve may be a throttle check valve. Such throttle check valve typically has a flow reducer in one direction and a bypass in the other direction. Particularly, the throttle check valve can be arranged such that a medium flow out of the proximal chamber of the vessel assembly can be or is reduced and a medium flow into the proximal chamber is unhindered. Like this, the speed of proximal movement of the dosing piston and eventually the driving piston can be reduced or adapted during charging and the speed of distal movement of the dosing piston and eventually the driving piston can be maximized during delivery.

Further, the delivery device may comprise a delivery speed adjuster coupled to or included in the throttle valve, wherein the throttle valve has an output port connected to the proximal side of the driving vessel and the delivery speed adjuster is configured to adjust a medium flow into the output port of the throttle valve. Such arrangement allows for efficiently adjusting the pressure regime such that the speed of charging of the liquid active ingredient formulation into product chamber can sophisticatedly be adapted as the need may be.

Besides the provision of the throttle valve, other structures may be implemented in the delivery device for lowering the speed of proximal movement of the dosing piston upon a pressure drop in the proximal chamber. For example, the dosing piston can be elastically supported in the proximal direction such that when a drop of pressure occurs in the proximal chamber the elastic support smoothens a proximal displacement of the dosing piston. In embodiments having a dosing piston as well as a driving piston, the two pistons can be coupled such that for a distal movement they are rigidly connected and for a proximal movement they are elastically connected. Such diverse coupling can, e.g., be embodied by a rigid rod combined with a coil or other spring.

In embodiments having a vessel assembly with dosing and driving vessels, the directional valve preferably is connected to the distal side of the driving vessel, in addition to being connected to the proximal side of the driving vessel. Like this, the pressure inside the driving vessel can be adapted distally and proximally of the driving piston by means of the directional valve. Advantageously, the directional valve is configured such that, in the charging position, the distal chamber of the driving vessel and the pressure medium port are in fluid connection, and, in the delivery position, the distal chamber of the driving vessel and the pressure medium port are fluid tight towards each other. In use, such arrangement allows for loading the active ingredient formulation into the product chamber by increasing the pressure inside the distal chamber of the driving vessel. Simultaneously, the pressure inside the proximal chamber of the driving vessel can be reduced. Thereby, the driving piston together with the dosing piston is proximally moved and active ingredient formulation is withdrawn into the product chamber. Thus, in this arrangement the driving piston can efficiently be distally and proximally moved by the pneumatic system of the delivery device without requiring any further structure or element.

For achieving an appropriate connection to the driving vessel, the directional valve may comprise a first output port and a second output port, wherein the first output port is connected to the proximal side of the driving vessel and the second output port is connected to the distal side of the driving vessel. Thereby, the directional valve preferably is configured such that in the delivery position the first output port is open and the second output port is closed, and in the charging position the first output port is closed and the second output port is open.

Moreover, the directional valve can comprise an inlet port, wherein the pressure medium port is connected to the inlet port of the directional valve. Such inlet port allows for an appropriate connection to the pressure medium port and for guiding of a pressure medium provided via the pressure medium port. For example, suitable pressure media can be carbon dioxide, Argon, Helium, compressed air, or the like. Thereby, the directional valve preferably is configured such that in the delivery position the inlet port is open and connected to the first output port, and in the charging position the inlet port is open and connected to the second output port.

Further, the directional valve can comprise a first exhaust port and a second exhaust port. Thereby, the directional valve is configured such that in the delivery position the first exhaust port is closed and the second exhaust port is connected to the second output port, and in the charging position the second exhaust port is closed and the first exhaust port is connected to the first output port. Such exhaust ports may allow for efficiently reducing the pressure where needed by means of the directional valve. In particular, for allowing the driving piston to be proximally or distally moved the pressure inside the proximal or distal chamber of the driving vessel can be reduced by means of the exhaust ports.

In some embodiments, the directional valve is a 5/2-way-valve. Such valve allows for efficiently implementing the directional valve for an accurate and efficient operation.

In some embodiments, a delivery one-way valve is arranged between the delivery outlet and the distal side of the vessel assembly such that fluid transfer from the vessel assembly to the delivery outlet is possible and fluid transfer from the delivery outlet to the vessel assembly is prevented. Like this, it can be assured that liquid is only provided out of the delivery outlet but not provided backwardly into the product chamber.

Similarly, a product one-way valve may be arranged between the product port and the distal side of the vessel assembly such that fluid transfer from the vessel assembly to the product port is prevented and fluid transfer from the product port to the vessel assembly is possible.

In some embodiments, the delivery device comprises a trigger configured to switch the directional valve into the delivery position. Such trigger allows for efficiently activating the delivery device. It can be embodied in various ways adapted to the design of the delivery device.

Thereby, the directional valve may comprise a resetter configured to switch the directional valve into the charging position. The resetter of the directional valve preferably comprises a spring element forcing the directional valve into the charging position. The spring element can be any elastic member such as a coil spring or the like. By such resetter it can be achieved that the directional valve is always in the same zero position, i.e. the charging position, when not activated.

The term “activate” in connection with the delivery device relates to a typically user initiated operation of the device. For example, the delivery device can be activated by a user by pulling the trigger or manipulating/actuating a similar switching structure. The delivery device can also be automatically activated such as, for example, by an electronic controller or control system.

In another aspect, the disclosure provides a delivery system for injecting a liquid active ingredient formulation into a plant. The delivery system has a product reservoir housing the liquid active ingredient formulation, a pressure medium reservoir housing a pressurized gas, and a delivery device. The delivery device comprises a vessel assembly having a proximal side and a distal side connected to the product reservoir, a delivery outlet connected to the distal side of the vessel assembly, a dosing piston movably arranged inside the vessel assembly such that a variable product chamber is formed between the dosing piston and the distal side of the vessel assembly, a directional valve connected to the proximal side of the vessel assembly and to the pressure medium reservoir, and a proximal chamber limited by the proximal side of the vessel assembly and reciprocally variable relative to the product chamber. The directional valve is configured to switch between a delivery position in which the proximal chamber of the vessel assembly and the pressure medium reservoir are in fluid connection, and a charging position in which the proximal chamber of the vessel assembly and the pressure medium reservoir are fluid tight towards each other.

In some embodiments, the vessel assembly of the delivery device comprises a dosing vessel having the distal side and a driving vessel having a distal side and the proximal side, the delivery device further comprises a driving piston movably arranged inside the driving vessel such that a variable distal chamber is formed between the driving piston and the distal side of the driving vessel and the variable proximal chamber is formed between the driving piston and the proximal side of the driving vessel, and the driving piston is cinematically coupled to the dosing piston.

In some embodiments, the delivery system comprises a throttle arrangement configured to throttle a pressure medium supply out of the proximal chamber of the vessel assembly of the delivery device. The throttle arrangement can, e.g., be or comprise a throttle valve and particularly a throttle valve of the delivery device. Alternatively, it can be any structure or mechanism cushioning, smoothening or slowing a proximal movement of the dosing piston upon a drop of pressure in the proximal chamber.

In some embodiments, the throttle arrangement comprises a delivery speed adjuster configured to adjust the pressure medium supply out of the proximal chamber of the vessel assembly of the delivery device. Such delivery speed adjuster can be used to charge the active ingredient formulation at an appropriate speed into the product chamber. Thereby, the speed can be adapted in accordance with properties of the active ingredient formulation and/or the treatment to be applied to the plant.

In some embodiments, the directional valve of the delivery device is configured to provide a fluid connection between the proximal chamber of the driving vessel of the delivery device and the pressure medium reservoir in the delivery position, and a fluid connection between the distal chamber of the driving vessel of the delivery device and the pressure medium reservoir in the charging position. Like this, it may efficiently be achieved that, in the delivery position, a pressure inside the proximal chamber is increased such that the delivery vessel piston is distally moved. Vice versa, by increasing the pressure inside the distal chamber in the charging position, the two pistons can conjointly be proximally moved. Thus, such arrangement may allow for precisely move the pistons in distal and proximal axial directions.

In some embodiments, the directional valve of the delivery device is configured to provide a fluid connection between the distal chamber of the driving vessel of the delivery device and the product reservoir in the delivery position, and a fluid connection between the proximal chamber of the driving vessel of the delivery device and the product reservoir in the charging position. When the delivery vessel piston and also the dosing piston are distally moved, the content of the product chamber is advanced through or supplied out of the delivery outlet. Together with the delivery vessel piston also the dosing piston is distally moved and the content of the product chamber is advanced through the delivery outlet. Vice versa, by proximally moving the two pistons, the product chamber is enlarged such that active ingredient formulation is withdrawn from the product reservoir into the product chamber.

In some embodiments, the delivery device of the delivery system is configured to be in the delivery position when activated and in the charging position when not activated. By embodying the delivery system with the delivery device being in charging position, it can be achieved that the delivery device typically is in a ready-to-use status. By activating the delivery device a dosage of the active ingredient formulation can be delivered.

In some embodiments, the pressure medium reservoir and/or the product reservoir comprise an adjustable pressure control valve. Such control valves allow for adjusting a pressure inside the respective reservoir such that provision of the active ingredient formulation and/or pressure medium provision can be controlled.

In some embodiments, the product reservoir is pressurized. By pressurizing the product reservoir the provision of the liquid active ingredient formulation into the dosing chamber can be assisted. Such assisted provision can be particularly helpful when a liquid is involved which has a comparably high viscosity. Such situation can, e.g. be given where biological or bio-chemical active ingredient formulations are used.

Thereby, in some embodiments, a pressure inside the product reservoir is in a range of about 0.1 bar to about 4 bar, or in a range of about 0.5 bar to about 3.5 bar, or in a range of about 1 bar to about 3 bar, or in the range of about 0.8 bar to about 4 bat. By such adjustment or limitation of the pressure inside the product reservoir it may be achieved that provision of the liquid is assisted with out risking leakage, unintended bypassing or the like. For example, by appropriately limiting the pressure impairment of the function one-way valves or other valves may be reduced or prevented.

Even though various types of gas are suitable to be used as pressurized gas in the delivery system, e.g. Argon, Helium or air, in some embodiments the pressurized gas is pressurized carbon dioxide (CO₂). Pressurized CO₂ may provide various benefits compared to other gases. In particular, CO₂ has several properties particularly suitable for the delivery system according to the invention. For example, CO₂ can efficiently be compressed in that it is available in liquid form at an appropriate pressure such that comparably little space is required to store it relative the gas form. Further, it can be used without any specific security measures as to toxicity or the like. For example, exhausted CO₂ can be provided in the atmosphere. Still further, exhausted CO₂ can be delivered into the product reservoir where it can be used as protective gas for preventing contamination or reactions in the active ingredient formulation. Also, CO₂ is economically available since it is used in a broad variety of applications in daily life.

The present disclosure also provides methods of using the devices and systems of this disclosure for delivery of fluid formulation to or into a plant. In some embodiments, the method of using the system comprises pneumatically or hydraulically charging the delivery device with fluid formulation, placing the delivery device in fluid communication with a plant (or plants), and thereafter pneumatically or hydraulically delivering a dose of the liquid formulation to the plant (or plants). In some embodiments, the delivery device is configured for use with a drill bit. In some embodiments, the delivery device is configured for use with an injection tip such as the injection tips described in PCT/EP2019/070119 (Injection Systems, Injection Tools and Methods for Same), filed Jul. 25, 2019, the entire disclosure of which is hereby incorporated by reference. In some such embodiments wherein the delivery device is configured for use with a drill bit or injection tip or the like, placing the delivery device in fluid communication with a plant comprises inserting at least a portion of the bit or tip into a post portion of the plant.

In some embodiments, wherein the delivery device is configured to hold only a single dose of liquid formulation, the method comprises repeatedly deliver doses of formulation by iteratively pneumatically or hydraulicaly charging the delivery device with a dose of fluid formulation and pneuatically or hudraulically delivering the dose of fluid formulation from the device to the plant or plants as many times as desired. In some embodiments, the delivery device is configured to hold multiple doses of fluid formulation such that it is not necessary to recharge the delivery device between dose applications. Thus, for example, in embodiments wherein the device is configured with a chamber that holds multiple doses of liquid formulation, two or more doses may be delivered to the same plant in the same location, or two or more doses may be delivered tot he same pant in one or more different locations, or one or more doses may ber delivered to multiple plants in series, in all such cases without the need for charging the device before each dose application (until the chamber no longer contains or no longer contains sufficient or a desired amount of fluid formulation).

In some method embodiments, the delivery device remains in fluid communication with the same plant (or plants) between delivery of doses. In some such method embodiments, one or more additional doses are delivered to the same plant (or plants) in the same location as the first dose. In other such method embodiments, one or more additional doses are delivered to the same plant (or plants) but in a different location from the first dose. For example, in some embodiments wherein the delivery device is equipped with a drill bit or injection tip, the drill bit or injection tip is removed from the post portion of the plant after application of the first dose and reinserted into a different location of the post portion of the same plant. In some method embodiments, the delivery device is placed in fluid communication with a different plant (or plants) between doses. In some such method embodiments, wherein the delivery device is configured with a drill bit or injection tip, the device may be removed from a plant and inserted into a second plant between dose applications.

While the disclosure provides certain specific embodiments, the invention is not limited to those embodiments. A person of ordinary skill will appreciate from the description herein that modifications can be made to the described embodiments and therefore that specification is broader in scope than the described embodiments. All examples are therefore non-limiting.

### BRIEF DESCRIPTION OF THE DRAWINGS

FIG. 1 is a pictorial representation of an embodiment of a plant fluid delivery system according to this disclosure comprising an embodiment of a plant injection device according to this disclosure;

FIG. 2 shows a functional diagram of the delivery system of FIG. 1;

FIG. 3 shows a functional diagram of a second embodiment of a plant fluid delivery system according to this disclosure with a second embodiment of a plant injection device according to this disclosure; and

FIG. 4 shows a functional diagram of a third embodiment of a plant fluid delivery system according to this disclosure with a third embodiment of a plant injection device according to this disclosure.

### DESCRIPTION

Detailed descriptions of one or more embodiments are provided herein. It is to be understood, however, that the devices, systems and methods according to this disclosure may be embodied in various forms. Therefore, specific details disclosed herein are not to be interpreted as limiting, but rather as a representative basis for the claims and for teaching one skilled in the art to employ the present devices, systems and methods in any appropriate manner.

Unless defined otherwise, all technical and scientific terms used herein have the same meaning as is commonly understood by one of ordinary skill in the art to which this disclosure belongs. In the event that there is a plurality of definitions for a term herein, those in this section prevail unless stated otherwise.

Where ever the phrase “for example,” “such as,” “including” and the like are used herein, the phrase “and without limitation” is understood to follow unless explicitly stated otherwise. Similarly “an example,” “exemplary” and the like are understood to be non-limiting.

The term “substantially” allows for deviations from the descriptor that don't negatively impact the intended purpose. Descriptive terms are understood to be modified by the term “substantially” even if the word “substantially” is not explicitly recited.

The term “about” is meant to account for variations due to experimental or measurement error. All measurements or numbers are implicitly understood to be modified by the word about, even if the measurement or number is not explicitly modified by the word about.

The terms “comprising” and “including” and “having” and “involving” and the like are used interchangeably and have the same meaning. Similarly, “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a device having components a, b, and c” means that the device includes at least components a, b and c. Similarly, the phrase: “a method involving steps a, b, and c” means that the method includes at least steps a, b, and c.

Where ever the terms “a” or “an” are used, “one or more” is understood unless explicitly stated otherwise or such interpretation is nonsensical in context.

As used herein, “trunk” also refers to “stem” and “stem” also refers to “trunk”. Thus, for example, the phrase “trunk of a plant” also is interpreted to mean “stem of a plant,” and “trunk of a tree” is also interpreted to mean “stem of a plant,” unless nonsensical in context.

Further, in the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

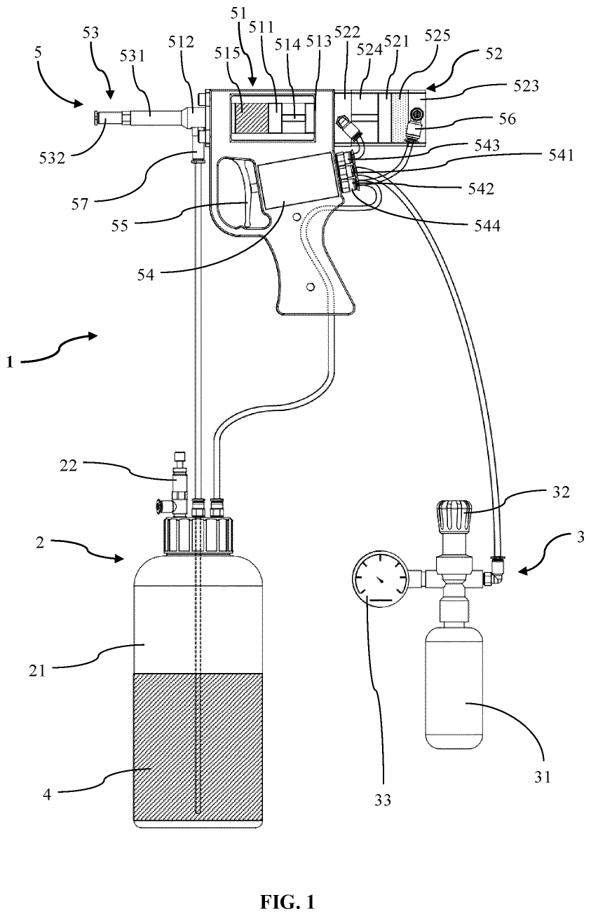

Referring now to the figures, FIG. 1 shows a first embodiment of a delivery system 1 which is arranged for injecting a liquid active ingredient formulation 4 into a plant. The delivery system 1 has: a product reservoir 2 housing the fluid formulation 4, such as a liquid active ingredient formulation; a pressure medium reservoir 3 housing a pressure medium; and, a first embodiment of a delivery device 5 according to the disclosure. The product reservoir 2 and the pressure medium reservoir 3 are in fluid communication with the delivery device 5. In use, both loading of the delivery device 1 with fluid formulation from the product reservoir 2 and delivery of fluid formulation to a plant from the delivery device 1 is controlled pneumatically or hydraulically by operation of the pressure medium reservoir. In some embodiments, liquid active formulation is loaded into the delivery device 5 and delivered to a plant from the delivery device 5 pneumatically by operation of the pressure medium reservoir. In some such embodiments, under conditions of use, the pressure medium is in liquid form when housed in the pressure medium reservoir 3, and in gas form when released from the pressure medium reservoir into the delivery device 5. For example, the pressure medium can be carbon dioxide, which while housed in the pressure medium reservoir 3 is pressurized into a liquid form, returning to gas form when releaed from the pressure medium reservoir 3 into the delivery device 5.

The delivery device 5 comprises a vessel assembly with a dosing cylinder 51 as dosing vessel and a driving cylinder 52 as a driving vessel. It further comprises a delivery outlet 53 and a 5/2-way valve 54 as directional valve. a carbon dioxide reservoir 3 housing pressurized carbon dioxide as pressure medium

At a distal side 512 as distal side of the vessel assembly, the dosing cylinder 51 is equipped with a product port 57. The product port 57 has a product one-way valve and is connected to the product reservoir 2 via a tube. The delivery outlet 53 is arranged at the distal side 512 of the dosing cylinder 51. It has a nose-shaped spout 531 distally equipped with a delivery one-way valve 532.

Inside the dosing cylinder 51 a dosing piston 511 is arranged. The dosing piston 511 is axially movable between the distal side 512 and a proximal side 513. Thereby, a variable product chamber 515 is formed between a distal face of the dosing piston 511 and the distal side 512 of the dosing cylinder 51.

The driving cylinder 52 has a distal side 522 and a proximal side 523 as proximal side of the vessel assembly. Inside the driving cylinder 52 a driving piston 521 is axially movable arranged such that a variable distal chamber 524 is formed between the driving piston 521 and the distal side 521 of the driving cylinder 52, and a variable proximal chamber 525 is formed between the driving piston 521 and the proximal side 523 of the driving cylinder 52. The driving piston 521 is cinematically coupled to the dosing piston 511 by an axial rigid rod 514 such that the two pistons 511, 521 together are axially movable to the left and right.

The 5/2-way valve 54 has five ports, i.e. an input port 541, a first output port 542, a second output port 543, a first exhaust port 544 and a second exhaust port 545. The input port 541 is embodied as pressure medium port and connected to the carbon dioxide reservoir 3 via a tube. The first output port 542 is connected to the proximal side 523 of the driving cylinder 52 via a tube. The second output port 543 is connected to the distal side 522 of the driving cylinder 52 via a tube and via a throttle valve 56 as throttle arrangement of the delivery system 1. The first and second exhaust ports 544, 545 are connected to the product reservoir 2 and, particularly, a gas containing upper section thereof via respective tubes.

The 5/2-way valve 54 is configured to switch between two positions. In particular, as will be shown in more detail below, it can be switched on the one hand into a delivery position in which the proximal chamber 525 of the delivery cylinder 52 is in fluid connection with the carbon dioxide reservoir 3 and the distal chamber 524 of the delivery cylinder 52 is fluid tight towards the carbon dioxide reservoir 3. On the other hand, the 5/2-way valve 54 can be switched into a charging position, in which the distal chamber 524 of the driving cylinder 52 is in fluid connection with the carbon dioxide reservoir 3 and the proximal chamber 525 of the driving cylinder 52 is fluid tight towards the carbon dioxide reservoir 3.

The delivery device 5 further has a trigger 55 which is coupled to the 5/2-way valve 54. To activate the delivery device 5 the trigger is to be pulled by a user. Thereby, the 5/2-way valve 54 is switched from the charging position to the delivery position.

The carbon dioxide reservoir 3 comprises a pressure cylinder 31 in which the pressurized carbon dioxide is housed in liquid form. The carbon dioxide reservoir 3 has a pressure reducing valve 32 and a pressure display 33 for indicating the actual pressure inside the pressure cylinder 31. By means of the pressure reducing valve 32, a pressure of the carbon dioxide supplied out of the pressure cylinder 31 can be manually adjusted.

The product reservoir 2 comprises a bottle body 21 housing an amount of the liquid active ingredient formulation 4, i.e. the product. In a top portion of the bottle body 21 carbon dioxide is located as protective gas. The product reservoir 2 further comprises a pressure control valve 22 by means of which the pressure inside the bottle body 21 can be controlled. For example, the pressure inside the bottle body can be adjusted to be about 1.5 bar.

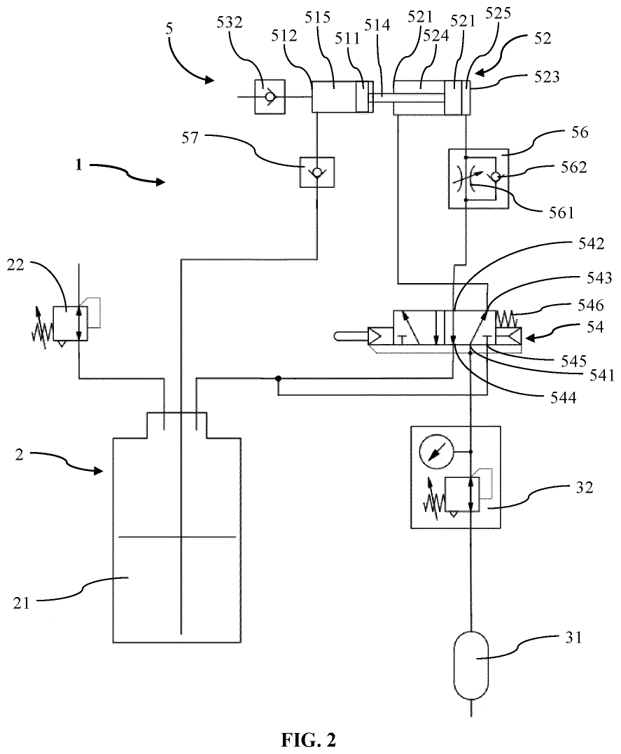

In FIG. 2 a schematic functioning diagram of the delivery system 1 is shown. Therein, it can be seen that the 5/2-way valve 54 is configured to take two positions, i.e. the charging position depicted on the right-hand side in FIG. 2 and the delivery position depicted on the left-hand side in FIG. 2. The 5/2-way valve 54 is further equipped with a spring element 546 pushing the 5/2-way valve 54 into the charging position when not being activated by a user pulling the trigger 55.

The throttle valve 56 has an input port 564 and an output port 563. The input port 564 of the throttle valve 56 is connected to the first output port 542 of the 5/2-way valve 54 via a tube. The output port 563 is directly mounted to the proximal side 523 of the driving cylinder 52.

In the charging position of the 5/2-way valve 54, the first output port 542 is in fluid connection with the first exhaust port 544. Thus, the proximal chamber 525 of the driving cylinder 52 is in fluid connection with the product reservoir 2. Thereby, the carbon dioxide can exhaust from the proximal chamber 525 via the throttle valve 56 and the 5/2-way valve 54 into the top portion of the bottle body 21 of the product reservoir 2. Thereby, the supply of the carbon dioxide out of the proximal chamber 525 is controlled by the throttle valve 56. More specifically, the throttle valve 56 adjustably limits the carbon dioxide supply.

At the same time, the input port 541 of the 5/2-way valve 54 is in fluid connection with the second output port 543. Thus, the distal chamber 524 of the driving cylinder 52 is in fluid connection with the carbon dioxide reservoir 3. Thereby, the pressurized carbon dioxide is provided from the pressure cylinder 31 via the pressure reducing valve 32 and the 5/2-way valve 54 into the distal chamber 524 of the driving cylinder 52. Due to the carbon dioxide being pressurized, the driving piston 521 is proximally moved to the right. Together with the driving piston 521 also the dosing piston 511 coupled to the driving piston 521 via the rod 514 is proximally moved to the right. This results in the product chamber 515 being enlarged such that active ingredient formulation 4 is withdrawn from the product reservoir 2 via the product one-way valve of the product port 57 into the product chamber 515 of the dosing cylinder 51. The second exhaust port 545 of the 5/2-way valve 54 is closed. The delivery one-way valve 532 of the delivery outlet 53 prevents that the active ingredient formulation is provided out of the delivery outlet 53.

In the delivery position of the 5/2-way valve 54, the second output port 543 is in fluid connection with the second exhaust port 545. Thus, the distal chamber 524 of the driving cylinder 52 is in fluid connection with the product reservoir 2. Thereby, the carbon dioxide can exhaust from the distal chamber 524 via the 5/2-way valve 54 into the top portion of the bottle body 21 of the product reservoir 2. This carbon dioxide is used as protective gas in the bottle body 21 and for pressurizing the bottle body 21. At the same time, the input port 541 of the 5/2-way valve 54 is in fluid connection with the first output port 542. Thus, the proximal chamber 525 of the driving cylinder 52 is in fluid connection with the carbon dioxide reservoir 3. Thereby, the pressurized carbon dioxide can be provided from the pressure cylinder 31 via the pressure reducing valve 32, the 5/2-way valve 54 and the throttle valve 56 into the proximal chamber 525 of the driving cylinder 52. Thereby, the carbon dioxide supplied via a free unidirectional bypass 562 of the throttle valve 56 into the proximal chamber 525. Due to the carbon dioxide being pressurized, the driving piston 521 is distally moved to the left. Together with the driving piston 521 also the dosing piston 511 is distally moved to the left. This results in the product chamber 515 being reduced such that active ingredient formulation 4 is forwarded out of the delivery outlet 53 via the delivery one-way valve 532. The first exhaust port 544 of the 5/2-way valve 54 is closed. The product one-way valve of the product port 57 prevents that the active ingredient formulation is provided towards the product reservoir 2.

The throttle valve 56 has an adjustable narrowing section 561 as charging speed adjuster of the delivery system 1, which allows for defining an extent of supply or feed-through of the carbon dioxide from the proximal chamber 525 of the driving cylinder 52. By such definition, when the directional valve 54 is in its charging position, the pressure reduction applied in the proximal chamber 525 can be adjusted for achieving an appropriate speed of proximally moving the driving piston 521. In particular, the speed can be adjusted to achieve an active ingredient formulation provision complying with the conditions given by the properties of the active ingredient formulation 4. The bypass 562 allows the carbon dioxide to be provided or supplied into the proximal chamber 525 of the driving cylinder 52 when the directional valve 54 is in its delivery position.

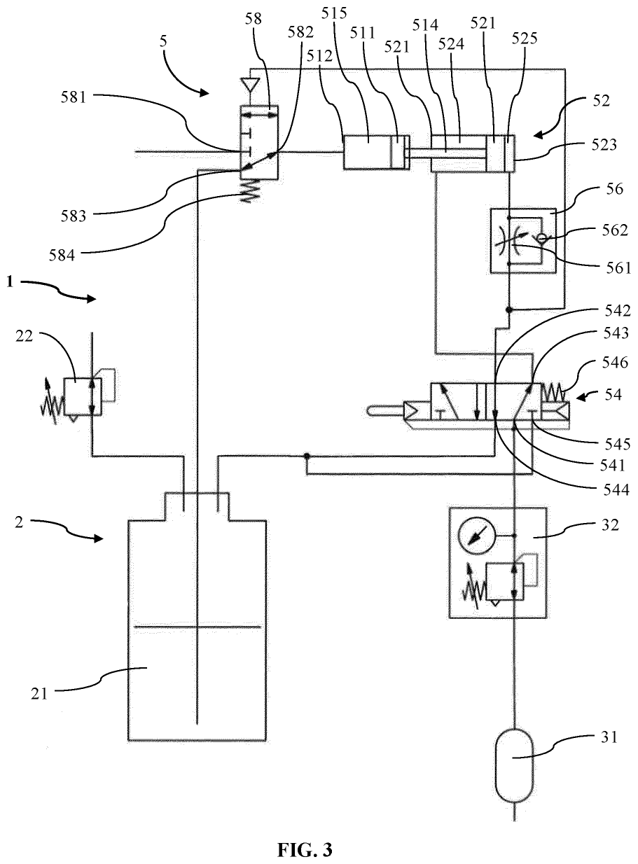

FIG. 3 shows a schematic functioning diagram of a second embodiment of a delivery system 1 according to the invention which comprises a second embodiment of a delivery device 5 according to the invention. Unless differently described in the following, the second embodiments of delivery system 1 and device 5 function in correspondence with the first embodiments of delivery system 1 and device 5 described in connection with FIG. 1 and FIG. 2. More specifically, the components and features of the second system 1 and device 5 which work or function the same as the corresponding components or features of the first system 1 and device 5 are generally not repeated in the following. In this context it is referred to the description of FIG. 1 and FIG. 2.

Instead of the product one-way valve of the product port 57 and the delivery one-way valve 532, the second delivery device 5 comprises a 3/2-way valve 58. The 3/2-way valve has an output port 581 connected to the delivery outlet (not shown in FIG. 3), a throughput port 582 connected to the product chamber 515 of the dosing cylinder 51 and an input port 583 as product port connected to the product reservoir 2.

The 3/2-way valve 57 is configured to switch between two positions. In particular, on the one hand, in a delivery position, which is the upper position shown in FIG. 3, the throughput port 582 is in fluid connection with the output port 581. Thus, the product chamber 515 of the dosing cylinder 51 is connected to the delivery outlet such that the active ingredient formulation can be delivered out of the delivery device 1. At the same time, the input port 583 is closed such that a fluid transfer to or from the product reservoir 2 is blocked. The delivery position of the 3/2-way valve 58 is identically set as the delivery position of the 5/2-way valve 56. More specifically, the 3/2-way valve 58 and the 5/2-way valve 56 are coupled such that they are commonly in the delivery position.

On the other hand, in a charging position, which is the lower position shown in FIG. 3, the throughput port 582 is in fluid connection with the input port 583. Thus, the product chamber 515 of the dosing cylinder 51 is connected to the product reservoir 2 such that the active ingredient formulation can be withdrawn or supplied from the bottle body 21 into the product chamber 515. At the same time, the output port 581 is closed such that a fluid transfer to or from the delivery outlet is blocked. The 3/2-way valve 58 further comprises a spring 584 which forces the 3/2-way valve 58 into its charging position when it is not activated.

Due to the implementation of the 3/2-way valve 58 instead of the two one-way valves, the second delivery device 5 is capable of managing a comparably high pressure inside the product side of the delivery system 1. This particularly allows for applying a comparably high pressure inside the bottle body 21 which may assist provision or supply of the active ingredient formulation into the product chamber 515. More specifically, the carbon dioxide exhausted of the distal chamber 524 and the proximal chamber 525 of the driving container 52 can be used for pressurizing the bottle body 21.

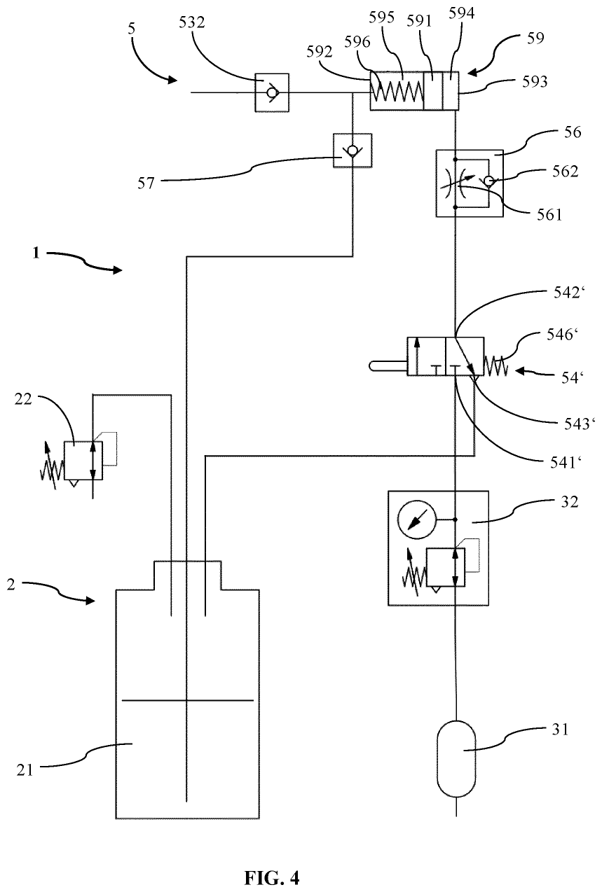

In FIG. 4 a schematic functioning diagram of a third embodiment of a delivery system 1 according to the invention is shown, which comprises a third embodiment of a delivery device 5 according to the invention. Unless differently described in the following, the third embodiments of delivery system 1 and device 5 function in correspondence with the first embodiments of delivery system 1 and device 5 described in connection with FIG. 1 and FIG. 2 above. More specifically, the components and features of the third system 1 and device 5 which work or function the same as the corresponding components or features of the first system 1 and device 5 are generally not repeated in the following. Rather, it is referred to the description of FIG. 1 and FIG. 2 in this connection.

Instead of the vessel assembly of the first delivery device having the dosing and the delivery cylinders 51, 52, the vessel assembly of the third delivery device has one single cylinder 59 with a distal side 592 and a proximal side 593. Inside the single cylinder 56, a dosing piston 591 is arranged which tightly separates the single cylinder in a proximal chamber 594 and a distal product chamber 595. In the product chamber 595 a spring 596 is positioned which is arranged to force the dosing 591 piston into a distal direction.

Further, instead of the 5/2-way valve 54 of the first delivery device 1, the third delivery device is equipped with a 3/2-way valve 54′ as directional valve. The 3/2-way valve 54′ has an input port 541′, an output port 542′ and an exhaust port 543′. The input port 541′ forms a pressure medium port of the delivery device 5. It is connected to the pressure cylinder 31 of the delivery system 1 via the pressure reducing valve 32 by means of tubes. The output port 542′ is connected to the proximal chamber 594 of the single cylinder 59 via the throttle valve 56 mounted to the proximal side of the single cylinder 59 by means of a tube. The exhaust port 543′ is connected to the bottle body 21 of the product reservoir 2 by means of a tube.

The 3/2 valve 54′ is configured to switch between two positions, i.e. a charging position and a delivery position. In particular, in the charging position, which is the right-hand position shown in FIG. 4, the output port 542′ is in fluid connection with the exhaust port 543′. Thus, the proximal chamber 594 of the single cylinder 59 is connected to the bottle body 21 of the product reservoir 2. The input port 541′ is blocked or closed. The spring 596 pushes the dosing piston 591 towards the proximal side 593 of the single cylinder 59, i.e. in a proximal direction. Thereby, carbon dioxide located in the proximal chamber 594 is forwarded via the throttle valve 56 and the 3/2-way valve 54′ into the bottle body 21. The throttle valve 56 allows for adjusting the carbon dioxide flow through it such that the speed of moving the dosing piston 591 likewise is adjusted. The carbon dioxide provided into bottle body 21 is used as protective gas and for smoothly pressurizing the bottle body 21. By the spring 596 proximally moving the dosing piston 591, the product chamber 595 of the single cylinder 59 is enlarged. Thereby, liquid active ingredient formulation is withdrawn from the bottle body 21 via the product one-way valve of the product port 57 into the product chamber 595. The 3/2-way valve 54′ has a spring 546′ which pushes the 3/2-way valve 54′ into the charging position.

In the delivery position of the 3/2-way valve 54′, which is the left-hand position depicted in FIG. 4, the input port 541′ is in fluid connection with the output port 542′. The exhaust port 543′ is closed. Thereby, the pressure cylinder 31 is connected to the proximal chamber 594 via the pressure reducing valve 32, the 3/2-way valve 54′ and the throttle valve 56. More specifically, the pressure reducing valve 32 allows for adjusting a pressure by which the carbon dioxide is provided. The carbon dioxide flows through the 3/2-way valve 54′ and the bypass 562 of the throttle valve 56 into the proximal chamber 594 of the single cylinder 59. Like this, the dosing piston is moved against the force of the spring 596 towards the distal side 592 of the single cylinder 59. The volume of the product chamber 595 is thereby reduced and the active ingredient formulation is supplied through the delivery one-way valve 532 out of the delivery outlet 53. For being in the delivery position, the 3/2-way valve 54′ or the delivery device 5 has to be activated.

This description and the accompanying drawings that illustrate aspects and embodiments of the present invention should not be taken as limiting the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the FIGS. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. The term about is intended to take into account experimental or measurement error. Components described as coupled or connected may be electrically or mechanically directly coupled, or they may be indirectly coupled via one or more intermediate components. Any reference signs in the claims should not be construed as limiting the scope.

1-31. (canceled)

32. A delivery device for injecting a liquid active ingredient formulation into a plant, comprising:
a vessel assembly having a distal side and a proximal side;
a delivery outlet connected to the distal side of the vessel assembly;
a product port connected to the distal side of the vessel assembly;
a dosing piston movably arranged in the vessel assembly such that a variable product chamber is formed between the dosing piston and the distal side of the vessel assembly;
a directional valve connected to the proximal side of the vessel assembly;
a proximal chamber limited by the proximal side of the vessel assembly and reciprocally variable relative to the product chamber; and
a pressure medium port connected to the directional valve,
wherein the directional valve is configured to switch between a delivery position in which the proximal chamber of the vessel assembly and the pressure medium port are in fluid connection, and a charging position in which the proximal chamber of the vessel assembly and the pressure medium port are fluid tight towards each other.

33. The delivery device of claim 32, wherein:
the vessel assembly comprises a dosing vessel having the distal side and a driving vessel having a distal side and the proximal side;
the delivery device comprises a driving piston movably arranged inside the driving vessel,
the dosing piston is movable inside the dosing vessel;
a variable distal chamber is formed between the driving piston and the distal side of the driving vessel;
the variable proximal chamber is formed between the driving piston and the proximal side of the driving vessel; and
the driving piston is cinematically coupled to the dosing piston.

34. The delivery device of claim 32, further comprising a throttle valve arranged between the directional valve and the proximal side of the vessel assembly.

35. The delivery device of claim 34, wherein the throttle valve is a throttle check valve.

36. The delivery device of claim 34, further comprising a delivery speed adjuster coupled to the throttle valve, wherein the throttle valve has an output port connected to the proximal side of the vessel assembly and the delivery speed adjuster is configured to adjust a medium flow into the output port of the throttle valve.

37. The delivery device of claim 33, wherein the directional valve is connected to the distal side of the driving vessel.

38. The delivery device of claim 37, wherein the directional valve comprises a first output port and a second output port, and wherein the first output port is connected to the proximal side of the driving vessel and the second output port is connected to the distal side of the driving vessel.

39. The delivery device of claim 38, wherein the directional valve is configured such that in the delivery position the first output port is open and the second output port is closed, and in the charging position the first output port is closed and the second output port is open.

40. The delivery device of claim 37, wherein the directional valve comprises an inlet port, and wherein the pressure medium port is connected to the inlet port of the directional valve.

41. The delivery device of claim 40, wherein the directional valve is configured such that in the delivery position the inlet port is open and connected to the first output port, and in the charging position the inlet port is open and connected to the second output port.

42. The delivery device of claim 37, wherein the directional valve comprises a first exhaust port and a second exhaust port.

43. The delivery device of claim 42, wherein the directional valve is configured such that in the delivery position the first exhaust port is closed and the second exhaust port is connected to the second output port, and in the charging position the second exhaust port is closed and the first exhaust port is connected to the first output port.

44. The delivery device of claim 37, wherein the directional valve is a 5/2-way-valve.

45. The delivery device of claim 32, wherein a delivery one-way valve is arranged between the delivery outlet and the distal side of the vessel assembly such that fluid transfer from the vessel assembly to the delivery outlet is possible and fluid transfer from the delivery outlet to the vessel assembly is prevented.

46. The delivery device of claim 32, wherein a product one-way valve is arranged between the product port and the distal side of the vessel assembly such that fluid transfer from the vessel assembly to the product port is prevented and fluid transfer from the product port to the vessel assembly is possible.

47. The delivery device of claim 32, comprising a trigger configured to switch the directional valve to the delivery position.

48. The delivery device of claim 47, wherein the directional valve comprises a resetter configured to switch the directional valve into the charging position.

49. The delivery device of claim 48, wherein the resetter of the directional valve comprises a spring element forcing the directional valve into the charging position.

50. A delivery system for injecting a liquid active ingredient formulation into a plant, having a product reservoir housing the liquid active ingredient formulation, a pressure medium reservoir housing a pressurized gas, and a delivery device, wherein the delivery device comprises
a vessel assembly having a proximal side and a distal side connected to the product reservoir,
a delivery outlet connected to the distal side of the vessel assembly,
a dosing piston movably arranged inside the vessel assembly such that a variable product chamber is formed between the dosing piston and the distal side of the vessel assembly,
a directional valve connected to the proximal side of the vessel assembly and to the pressure medium reservoir, and
a proximal chamber limited by the proximal side of the vessel assembly and reciprocally variable relative to the product chamber,
wherein the directional valve is configured to switch between a delivery position in which the proximal chamber of the vessel assembly and the pressure medium reservoir are in fluid connection, and a charging position in which the proximal chamber of the vessel assembly and the pressure medium reservoir are fluid tight towards each other.

51. The delivery system of claim 50, wherein
the vessel assembly of the delivery device comprises a dosing vessel having the distal side and a driving vessel having a distal side and the proximal side,
the delivery device comprises a driving piston movably arranged inside the driving vessel such that a variable distal chamber is formed between the driving piston and the distal side of the driving vessel and the variable proximal chamber is formed between the driving piston and the proximal side of the driving vessel, and
the driving piston is cinematically coupled to the dosing piston.

52. The delivery system of claim 50, comprising a throttle arrangement configured to throttle a pressure medium supply out of the proximal chamber of the vessel assembly of the delivery device.

53. The delivery system of claim 52, wherein the throttle arrangement comprises a delivery speed adjuster configured to adjust the pressure medium supply out of the proximal chamber of the vessel assembly of the delivery device.

54. The delivery system of claim 51, wherein the directional valve of the delivery device is configured to provide a fluid connection between the proximal chamber of the vessel assembly of the delivery device and the pressure medium reservoir in the delivery position, and a fluid connection between the distal chamber of the vessel assembly of the delivery device and the pressure medium reservoir in the charging position.

55. The delivery system of claim 51, wherein the directional valve of the delivery device is configured to provide a fluid connection between the distal chamber of the vessel assembly of the delivery device and the product reservoir in the delivery position, and a fluid connection between the proximal chamber of the vessel assembly of the delivery device and the product reservoir in the charging position.

56. The delivery system of claim 51, wherein the delivery device is configured to be in the delivery position when activated and in the charging position when not activated.

57. The delivery system of claim 51, wherein the pressure medium reservoir comprises an adjustable pressure reducing valve.

58. The delivery system of claim 51, wherein the product reservoir comprises an adjustable pressure control valve.

59. The delivery system of claim 51, wherein the product reservoir is pressurized.

60. The delivery system of claim 59, wherein a pressure inside the product reservoir is in a range of about 0.1 bar to about 4 bar, or in a range of about 0.5 bar to about 3.5 bar, or in a range of about 1 bar to about 3 bar.

61. The delivery system of claim 51, wherein the pressurized gas is pressurized carbon dioxide.

62. The delivery system of claim 51, wherein the delivery device further comprises:
a product port connected to the distal side of the vessel assembly; and
a pressure medium port connected to the directional valve.
